(19) United States
(12) Patent Application Publication
(10) Pub. No.: US 2025/0079039 A1
(43) Pub. Date: Mar. 6, 2025

(54) SECONDARY BATTERY AND BUS BAR

(71) Applicant: KABUSHIKI KAISHA TOSHIBA, Tokyo (JP)

(72) Inventors: Seishiro MATSUMURA, Yokohama Kanagawa (JP); Kuniaki YAMAMOTO, Yokohama Kanagawa (JP); Tatsumi MATSUO, Kokubunji Tokyo (JP); Shinya TANIKAWA, Kita Tokyo (JP); Wataru NITTA, Ota Tokyo (JP)

(21) Appl. No.: 18/605,554

(22) Filed: Mar. 14, 2024

(30) Foreign Application Priority Data
Aug. 29, 2023 (JP) 2023-139195

(51) Int. Cl. H01B 5/02; H01M 10/613; H01M 10/6551; H01M 50/209; H01M 50/503

(52) U.S. Cl. CPC H01B 5/02; H01M 10/613; H01M 10/6551; H01M 50/209; H01M 50/503

(57) ABSTRACT

According to one embodiment, a secondary battery includes a first battery cell including a first terminal, a second battery cell including a second terminal, and a bus bar. The bus bar includes a base portion, a first heat dissipation portion, a first opposing heat dissipation portion, a second heat dissipation portion, and a second opposing heat dissipation portion. The base portion includes first and second connecting portions. The first and second connecting portions are electrically connected to the first and second terminals, respectively. A first direction from the first connecting portion to the first opposing heat dissipating portion crosses a second direction from the first connecting portion to the second connecting portion. The first opposing heat dissipation portion is separated from the first connecting portion in the first direction. The second opposing heat dissipation portion is separated from the second connecting portion in the first direction.

### CROSS-REFERENCE TO RELATED APPLICATIONS

This application is based upon and claims the benefit of priority from Japanese Patent Application No. 2023-139195, filed on Aug. 29, 2023; the entire contents of which are incorporated herein by reference.

### FIELD

Embodiments described herein relate generally to a secondary battery and a bus bar.

### BACKGROUND

For example, in a large-capacity secondary battery, a plurality of battery cells are connected via a bus bar. It is desirable to improve heat dissipation in the connection part between the plurality of battery cells and the bus bar.

### BRIEF DESCRIPTION OF THE DRAWINGS

FIGS. 1A to 1C are schematic views illustrating a part of a secondary battery according to a first embodiment;

FIG. 2 is a schematic perspective view illustrating the secondary battery according to the first embodiment;

FIGS. 3A to 3C are schematic views illustrating a part of a secondary battery according to the first embodiment;

FIGS. 4A to 4C are schematic views illustrating a part of a secondary battery according to the first embodiment;

FIGS. 5A and 5B are schematic views illustrating a part of a secondary battery according to a second embodiment;

FIGS. 6A and 6B are schematic views illustrating a part of a secondary battery according to the second embodiment; and

FIGS. 7A to 7C are schematic views illustrating a part of a secondary battery according to the second embodiment.

### DETAILED DESCRIPTION

According to one embodiment, a secondary battery includes a first battery cell including a first terminal, a second battery cell including a second terminal, and a bus bar. The bus bar includes a base portion, a first heat dissipation portion, a first opposing heat dissipation portion, a second heat dissipation portion, and a second opposing heat dissipation portion. The base portion includes a first connecting portion and a second connecting portion. The first connecting portion is electrically connected to the first terminal. The second connecting portion is electrically connected to the second terminal. A first direction from the first connecting portion to the first opposing heat dissipating portion crosses a second direction from the first connecting portion to the second connecting portion. The first opposing heat dissipation portion is separated from the first connecting portion in the first direction. The first heat dissipation portion is continuous with the first connecting portion and the first opposing heat dissipation portion. A direction from the second connecting portion to the second opposing heat dissipation portion is along the first direction. The second opposing heat dissipation portion is separated from the second connecting portion in the first direction. The second heat dissipation portion is continuous with the second connecting portion and the second opposing heat dissipation portion.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with like reference numerals, and a detailed description is omitted as appropriate.

### First Embodiment

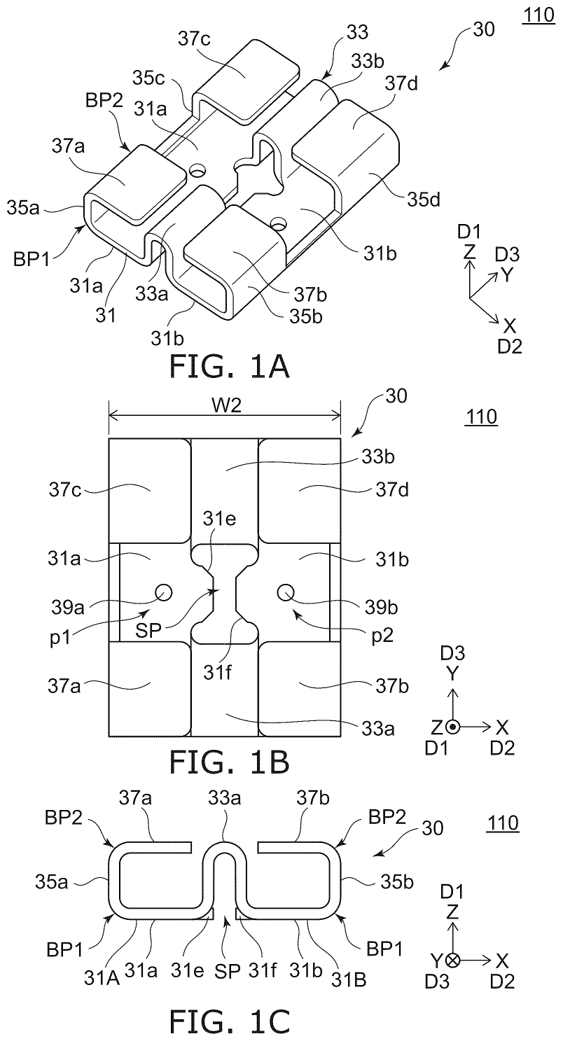

FIGS. 1A to 1C are schematic views illustrating a part of a secondary battery according to the first embodiment.

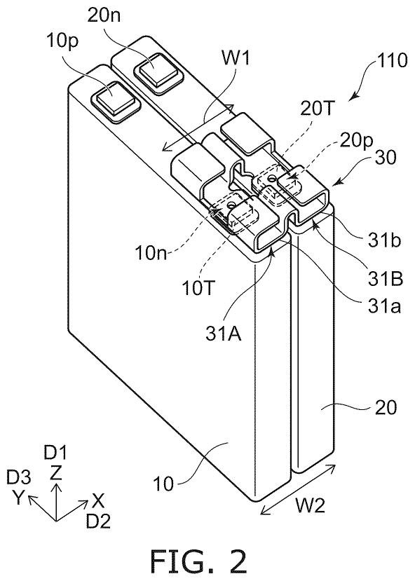

FIG. 2 is a schematic perspective view illustrating the secondary battery according to the first embodiment.

As shown in FIG. 2, a secondary battery 110 according to the first embodiment includes a first battery cell 10, a second battery cell 20, and a bus bar 30. In one example, the secondary battery 110 is a lithium-ion battery. The first battery cell 10 and the second battery cell 20 are lithium-ion battery cells.

The first battery cell 10 includes a first terminal 10T. The second battery cell 20 includes a second terminal 20T. For example, the first battery cell 10 includes a first positive electrode terminal 10p and a first negative electrode terminal 10n.v The second battery cell 20 includes a second positive electrode terminal 20p and a second negative electrode terminal 20n. The first terminal 10T is one of the first positive electrode terminal 10p and the first negative electrode terminal 10n. The second terminal 20T is one of the second negative electrode terminal 20n and the second positive electrode terminal 20p. In one example, the first terminal 10T is the first negative electrode terminal 10n, and the second terminal 20T is the second positive electrode terminal 20p. The first terminal 10T may be the first positive electrode terminal 10p, and the second terminal 20T may be the second negative electrode terminal 20n. In the example described below, the first terminal 10T is the first negative electrode terminal 10n, and the second terminal 20T is the second positive electrode terminal 20p.

The bus bar 30 electrically connects the first terminal 10T and the second terminal 20T. The bus bar 30 is electrically conductive. In one example, the bus bar 30 includes aluminum or an aluminum alloy.

FIGS. 1A to 1C illustrate the bus bar 30. FIG. 1A is a perspective view. FIG. 1B is a plan view. FIG. 1C is a side view. As shown in FIGS. 1A to 1C, the bus bar 30 includes a base portion 31, a first heat dissipation portion 35a, a first opposing heat dissipation portion 37a, a second heat dissipation portion 35b, and a second opposing heat dissipation portion 37b. The base portion 31 includes a first connecting portion 31a and a second connecting portion 31b.

As illustrated in FIG. 2, the first connecting portion 31a faces the first terminal 10T. The second connecting portion 31b faces the second terminal 20T. The first connecting portion 31a is electrically connected to the first terminal 10T. The second connecting portion 31b is electrically connected to the second terminal 20T. The electrical connection may be made by welding, for example.

As shown in FIG. 1A, a first direction D1 from the first connecting portion 31a to the first opposing heat dissipation portion 37a crosses a second direction D2 from the first connecting portion 31a to the second connecting portion 31b.

The first direction D1 is defined as a Z-axis direction. One direction perpendicular to the Z-axis direction is defined as an X-axis direction. A direction perpendicular to the Z-axis direction and the X-axis direction is defined as a Y-axis direction. The second direction D2 is, for example, the X-axis direction.

As shown in FIG. 2, a direction from the first terminal 10T to the second terminal 20T is along the second direction D2.

As shown in FIGS. 2 and 1C, the first connecting portion 31a includes a first face 31A. The first face 31A faces the first terminal 10T. The second connecting portion 31b includes a second face 31B. The second face 31B faces the second terminal 20T. For example, at least a part of the first face 31A crosses the first direction D1. For example, at least a part of the second face 31B crosses the first direction D1.

As shown in FIGS. 1A and 1C, the first opposing heat dissipation portion 37a is separated from the first connecting portion 31a in the first direction D1. The first heat dissipation portion 35a is provided between the first connecting portion 31a and the first opposing heat dissipation portion 37a. The first heat dissipation portion 35a is continuous with the first connecting portion 31a and the first opposing heat dissipation portion 37a. For example, at least a part of the first heat dissipation portion 35a may extend along the first direction D1.

As shown in FIGS. 1A and 1C, a direction from the second connecting portion 31b to the second opposing heat dissipation portion 37b is along the first direction D1. The second opposing heat dissipation portion 37b is separated from the second connecting portion 31b in the first direction D1. The second heat dissipation portion 35b is provided between the second connecting portion 31b and the second opposing heat dissipation portion 37b. The second heat dissipation portion 35b is continuous with the second connecting portion 31b and the second opposing heat dissipation portion 37b. For example, at least a part of the second heat dissipation portion 35b may extend along the first direction D1.

In the embodiment, for example, high heat dissipation is obtained by providing the first heat dissipation portion 35a and the first opposing heat dissipation portion 37a. For example, heat can be dissipated from both surfaces of each of the first heat dissipation portion 35a and the first opposing heat dissipation portion 37a. By providing the second heat dissipation portion 35b and the second opposing heat dissipation portion 37b, for example, high heat dissipation is obtained. For example, heat can be dissipated from both surfaces of each of the second heat dissipation portion 35b and the second opposing heat dissipation portion 37b. According to the embodiment, it is possible to provide a secondary battery and a bus bar capable of improving heat dissipation.

By providing the first heat dissipation portion 35a, the first opposing heat dissipation portion 37a, the second heat dissipation portion 35b, and the second opposing heat dissipation portion 37b, for example, a large volume is obtained in the bus bar 30. For example, a large heat capacity is obtained. For example, concentration of heat is suppressed.

As shown in FIGS. 1A and 1C, the bus bar 30 may further include a first bent portion BP1 and a second bent portion BP2. A plurality of first bent portions BP1 and a plurality of second bent portions BP2 may be provided. The first bent portion BP1 connects the first connecting portion 31a and the first heat dissipation portion 35a. The second bent portion BP2 connects the first heat dissipation portion 35a and the first opposing heat dissipation portion 37a.

Another first bent portion BP1 connects the second connecting portion 31b and the second heat dissipation portion 35b. Another second bent portion BP2 connects the second heat dissipation portion 35b and the second opposing heat dissipation portion 37b.

The bus bar 30 may be formed by bending a metal plate to be the bus bar 30. For example, press working may be applied. As shown in FIGS. 1A and 1C, in this example, the base portion 31 includes a first curved portion 33a. The first curved portion 33a connects the first connecting portion 31a and the second connecting portion 31b. A position of the first curved portion 33a in the second direction D2 is between a position of the first connecting portion 31a in the second direction D2 and a position of the second connecting portion 31b in the second direction D2. A part of the first curved portion 33a faces the first heat dissipation portion 35a in the second direction D2. Another part of the first curved portion 33a faces the second heat dissipation portion 35b in the second direction D2. The first curved portion 33a is separated from the first heat dissipation portion 35a in the second direction D2. The first curved portion 33a is separated from the second heat dissipation portion 35b in the second direction D2. The first curved portion 33a may have a function of dissipation heat.

As shown in FIGS. 1A to 1C, in this example, the bus bar 30 further includes a third heat dissipation portion 35c, a third opposing heat dissipation portion 37c, a fourth heat dissipation portion 35d, and a fourth opposing heat dissipation portion 37d. A direction from the first connecting portion 31a to the third opposing heat dissipation portion 37c is along the first direction D1. The third opposing heat dissipation portion 37c is separated from the first connecting portion 31a in the first direction D1. A third direction D3 from the first opposing heat dissipation portion 37a to the third opposing heat dissipation portion 37c crosses a plane including the first direction D1 and the second direction D2. The third direction D3 may be, for example, the Y-axis direction. The third heat dissipation portion 35c is provided between the first connecting portion 31a and the third opposing heat dissipation portion 37c. The third heat dissipation portion 35c is continuous with the first connecting portion 31a and the third opposing heat dissipation portion 37c. For example, at least a part of the third heat dissipation portion 35c may extend along the first direction D1.

A direction from the second connecting portion 31b to the fourth opposing heat dissipation portion 37d is along the first direction D1. The fourth opposing heat dissipation portion 37d is separated from the second connecting portion 31b in the first direction D1. A direction from the second opposing heat dissipation portion 37b to the fourth opposing heat dissipation portion 37d is along the third direction D3. The fourth heat dissipation portion 35d is provided between the second connecting portion 31b and the fourth opposing heat dissipation portion 37d. The fourth heat dissipation portion 35d is continuous with the second connecting portion 31b and the fourth opposing heat dissipation portion 37d. For example, at least a part of the fourth heat dissipation portion 35d may extend along the first direction D1.

As shown in FIGS. 1A and 1B, for example, the third opposing heat dissipation portion 37c is separated from the first opposing heat dissipation portion 37a in the third direction D3. The fourth opposing heat dissipation portion 37d is separated from the second opposing heat dissipation portion 37b in the third direction D3.

The first connecting portion 31a and the first terminal 10T may be connected (for example, welded) in a space between the third opposing heat dissipation portion 37c and the first opposing heat dissipation portion 37a. The second connecting portion 31b and the second terminal 20T may be connected (for example, welded) in a space between the fourth opposing heat dissipation portion 37d and the second opposing heat dissipation portion 37b. The welding may include, for example, laser welding. The welding may include, for example, spot welding.

As shown in FIG. 1A, the base portion 31 may further include a second curved portion 33b. A position of the second curved portion 33b in the second direction D2 is between the position of the first connecting portion 31a in the second direction D2 and the position of the second connecting portion 31b in the second direction D2. The second curved portion 33b connects the first connecting portion 31a and the second connecting portion 31b. A part of the second curved portion 33b faces the third heat dissipation portion 35c in the second direction D2. Another part of the second curved portion 33b faces the fourth heat dissipation portion 35d in the second direction D2.

The second curved portion 33b is separated from the first curved portion 33a in the third direction D3. In the space between the second curved portion 33b and the first curved portion 33a, connection (for example, welding) between the first connecting portion 31a and the first terminal 10T and connection (for example, welding) between the second connecting portion 31b and the second terminal 20T may be performed.

The first curved portion 33a and the second curved portion 33b may be formed by bending a metal plate serving as the bus bar 30. The first curved portion 33a and the second curved portion 33b may be obtained by, for example, press working.

For example, relative displacement between the first connecting portion 31a and the second connecting portion 31b and stress due to thermal expansion may occur. By providing the first curved portion 33a and the second curved portion 33b, stress due to displacement is alleviated. For example, the stress applied to the welded portion between the terminal of the battery cell and the base portion 31 is reduced. For example, high reliability is easily obtained in the secondary battery 110.

As shown in FIG. 1B, the first connecting portion 31a includes a first position p1. At the first position p1, the first connecting portion 31a is connected to the first terminal 10T. The second connecting portion 31b includes a second position p2. At the second position p2, the second connecting portion 31b is connected to the second terminal 20T.

For example, the first connecting portion 31a includes a first welding hole 39a. The second connecting portion 31b includes a second welding hole 39b. In the first welding hole 39a, the first connecting portion 31a is connected to the first terminal 10T. In the second welding hole 39b, the second connecting portion 31b is connected to the second terminal 20T. The first position p1 corresponds to, for example, the position of the first welding hole 39a. The second position p2 corresponds to, for example, the position of the second welding hole 39b.

For example, the first connecting portion 31a may include a first protruding portion 31e. The first protruding portion 31e protrudes toward the second position p2. For example, the second connecting portion 31b may include a second protruding portion 31f. The second protruding portion 31f protrudes toward the first position p1.

As shown in FIG. 1B, for example, a first gap SP may be provided between the first connecting portion 31a and the second connecting portion 31b. The first gap SP is provided, for example, between the first position p1 and the second position p2.

By providing at least one of the first protruding portion 31e and the second protruding portion 31f, a length of the first gap SP along the second direction D2 may be locally shortened between the first position p1 and the second position p2. The first protruding portion 31e and the second protruding portion 31f are, for example, wide regions.

By providing the first protruding portion 31e and the second protruding portion 31f, for example, low electrical resistance is easily obtained between the first connecting portion 31a and the first terminal 10T and between the second connecting portion 31b and the second terminal 20T. For example, heat generation during energization is suppressed.

Further, the surface area of the bus bar is increased, thereby improving heat dissipation.

As shown in FIG. 1B and FIG. 2, a length of the bus bar 30 along the second direction D2 is defined as a first width W1. As shown in FIG. 2, a length of the first battery cell 10 and the second battery cell 20 in the second direction D2 is defined as a second width W2. In the embodiment, the first width W1 is narrower than the second width W2.

By the first heat dissipation portion 35a and the first opposing heat dissipation portion 37a being provided in the bus bar 30 having the first width W1 being narrow and a small size, high heat dissipation is obtained even in the bus bar 30 having a small size. For example, a large heat capacity is obtained. For example, a temperature rise can be suppressed during laser welding of the bus bar 30 and during energization.

For example, the first curved portion 33a may be provided except between the first position p1 and the second position p2. The first gap SP is provided between the first connecting portion 31a and the second connecting portion 31b between the first position p1 and the second position p2. For example, the second curved portion 33b may be provided except between the first position p1 and the second position p2.

In the embodiment, for example, the first connecting portion 31a and the second connecting portion 31b may extend along the X-Y plane. In one example, at least a part of the first opposing heat dissipation portion 37a may extend along the X-Y plane. In one example, at least a part of the second opposing heat dissipation portion 37b may extend along the X-Y plane. For example, at least a part of the first opposing heat dissipation portion 37a is along a first crossing plane (for example, the X-Y plane) crossing the first direction D1. For example, at least a part of the second opposing heat dissipation portion 37b is along the first crossing plane. High heat dissipation is easily obtained.

In the embodiment, at least a part of the first opposing heat dissipation portion 37a may be inclined with respect to the X-Y plane. At least a part of the second opposing heat dissipation portion 37b may be inclined with respect to the X-Y plane.

As shown in FIG. 1A, in this example, at least a part of the first heat dissipation portion 35a is along a second crossing plane (for example, the Z-Y plane) crossing the second direction D2. At least a part of the second heat dissipation portion 35b is along the second crossing plane crossing the second direction D2. At least a part of the third heat dissipation portion 35c is along the second crossing plane crossing the second direction D2. At least a part of the fourth heat dissipation portion 35d is along the second crossing plane crossing the second direction D2.

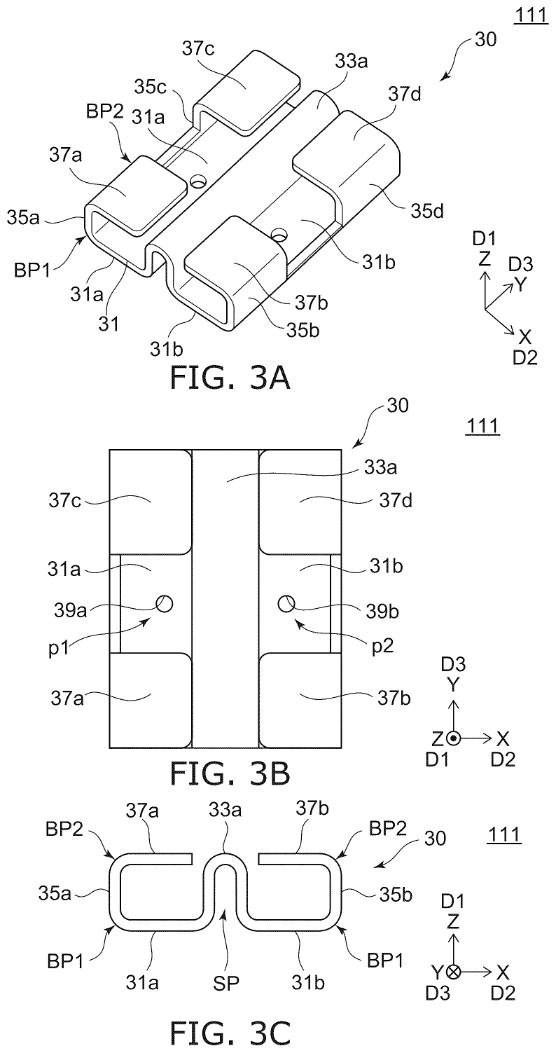

FIGS. 3A to 3C are schematic views illustrating a part of a secondary battery according to the first embodiment.

FIGS. 3A to 3C illustrate the bus bar 30 in a secondary battery 111 according to the embodiment. FIG. 3A is a perspective view. FIG. 3B is a plan view. FIG. 3C is a side view.

The bus bar 30 in the secondary battery 111 also includes the base portion 31, the first heat dissipation portion 35a, the first opposing heat dissipation portion 37a, the second heat dissipation portion 35b, and the second opposing heat dissipation portion 37b. In the secondary battery 111, the shape of the first curved portion 33a is different from the shape of the first curved portion 33a in the secondary battery 110. Except for this, the configuration of the secondary battery 111 may be the same as the configuration of the secondary battery 110.

In the secondary battery 111, a part of the first curved portion 33a faces the first heat dissipation portion 35a in the second direction D2. Another part of the first curved portion 33a faces the second heat dissipation portion 35b in the second direction D2. Still another part of the first curved portion 33a faces the third heat dissipation portion 35c in the second direction D2. Still another part of the first curved portion 33a faces the fourth heat dissipation portion 35d in the second direction D2.

In the secondary battery 111, the structure of the first curved portion 33a is simple. The bus bar 30 is easily manufactured. Also in the secondary battery 111, a secondary battery and a bus bar capable of improving heat dissipation can be provided.

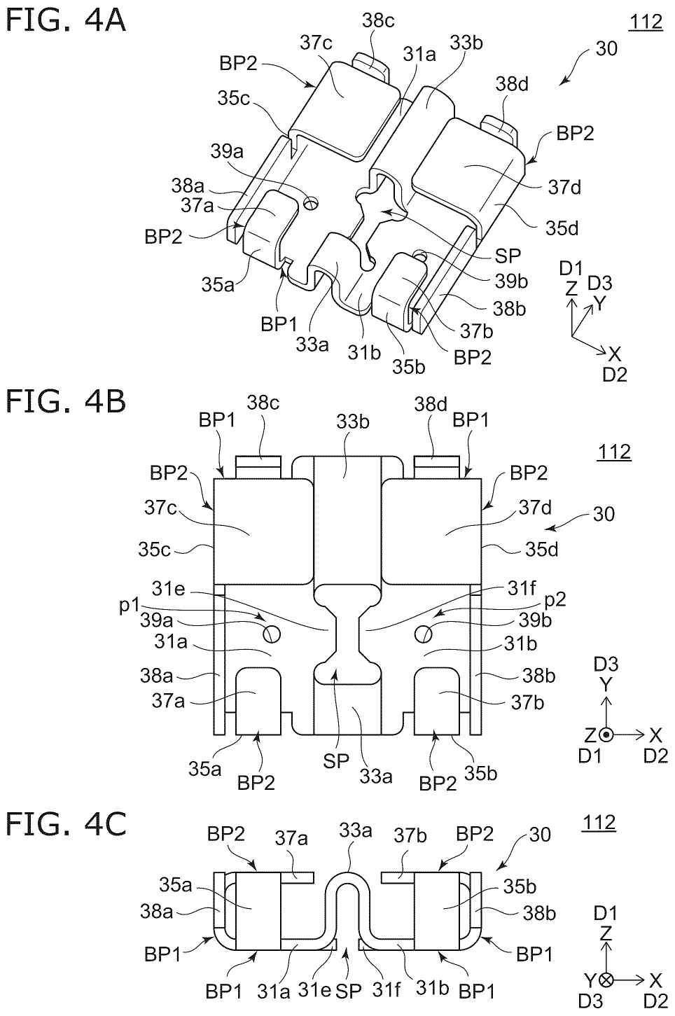

FIGS. 4A to 4C are schematic views illustrating a part of a secondary battery according to the first embodiment.

FIGS. 4A to 4C illustrate the bus bar 30 in a secondary battery 112 according to the embodiment. FIG. 4A is a perspective view. FIG. 4B is a plan view. FIG. 4C is a side view.

The bus bar 30 in the secondary battery 112 also includes the base portion 31, the first heat dissipation portion 35a, the first opposing heat dissipation portion 37a, the second heat dissipation portion 35b, and the second opposing heat dissipation portion 37b. In the secondary battery 112, the configurations of the first heat dissipation portion 35a and the second heat dissipation portion 35b are different from the configurations of the first heat dissipation portion 35a and the second heat dissipation portion 35b in the secondary battery 110. Except for this, the configuration of the secondary battery 112 may be the same as the configuration of the secondary battery 110.

In the secondary battery 112, at least a part of the first heat dissipation portion 35a is along a first plane (e.g., Z-X plane) including the first direction D1 and the second direction D2. At least a part of the second heat dissipation portion 35b is along the first plane (for example, the Z-X plane). At least a part of the third heat dissipation portion 35c is along a second plane (for example, the Z-Y plane) including the first direction D1 and the third direction D3. At least a part of the fourth heat dissipation portion 35d is along the second plane (for example, the Z-Y plane) described above. Also in the secondary battery 111, a secondary battery and a bus bar capable of improving heat dissipation can be provided.

A length of the first opposing heat dissipation portion 37a along the third direction D3 may be different from a length of the third opposing heat dissipation portion 37c along the third direction D3. A length of the second opposing heat dissipation portion 37b along the third direction D3 may be different from a length of the fourth opposing heat dissipation portion 37d along the third direction D3.

In the secondary battery 112, the bus bar 30 may include, for example, a first other heat dissipation portion 38a and a second other heat dissipation portion 38b. The first other heat dissipation portion 38a is connected to the first connecting portion 31a. The second other heat dissipation portion 38b is connected to the second connecting portion 31b. A direction from the first other heat dissipation portion 38a to the second other heat dissipation portion 38b is along the second direction D2. At least a part of the first other heat dissipation portion 38a and at least a part of the second other heat dissipation portion 38b are along the second plane (e.g., Z-Y plane) including the first direction D1 and the third direction D3.

In the secondary battery 112, the bus bar 30 may include, for example, a third other heat dissipation portion 38c and a fourth other heat dissipation portion 38d. The third other heat dissipation portion 38c is connected to the first connecting portion 31a. The fourth other heat dissipation portion 38d is connected to the second connecting portion 31b. A direction from the third other heat dissipation portion 38c to the fourth other heat dissipation portion 38d is along the second direction D2. At least a part of the third other heat dissipation portion 38c and at least a part of the fourth other heat dissipation portion 38d are along the first plane (e.g., Z-X plane) including the first direction D1 and the second direction D2.

By providing the first other heat dissipation portion 38a, the second other heat dissipation portion 38b, the third other heat dissipation portion 38c, and the fourth other heat dissipation portion 38d, higher heat dissipation is obtained.

In the secondary battery 112, for example, the first curved portion 33a may be provided except between the first position p1 and the second position p2.

### Second Embodiment

Also in a second embodiment, the bus bar 30 is connected to the first terminal 10T of the first battery cell 10 and the second terminal 20T of the second battery cell 20 (see FIG. 2).

Hereinafter, an example of the bus bar 30 according to the second embodiment will be described.

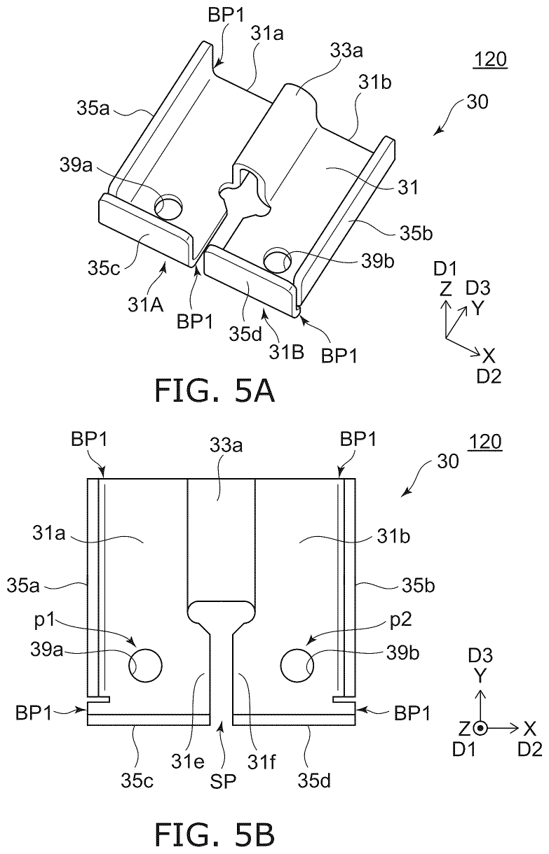

FIGS. 5A and 5B are schematic views illustrating a part of a secondary battery according to the second embodiment.

FIGS. 5A and 5B illustrate the bus bar 30 in a secondary battery 120 according to the embodiment. FIG. 5A is a perspective view. FIG. 5B is a plan view.

As shown in FIG. 5A and FIG. 2, the secondary battery 120 includes the first battery cell 10, the second battery cell 20, and the bus bar 30. As shown in FIG. 2, the first battery cell 10 includes the first terminal 10T. The second battery cell 20 includes the second terminal 20T.

As shown in FIG. 5A, in the secondary battery 120, the bus bar 30 includes the base portion 31, the first heat dissipation portion 35a, the second heat dissipation portion 35b, the third heat dissipation portion 35c, and the fourth heat dissipation portion 35d.

The base portion 31 includes the first connecting portion 31a, the second connecting portion 31b, and the first curved portion 33a. The first connecting portion 31a is electrically connected to the first terminal 10T (see FIG. 2). The second connecting portion 31b is electrically connected to the second terminal 20T (see FIG. 2).

As shown in FIG. 5A and FIG. 2, the first connecting portion 31a includes the first face 31A facing the first terminal 10T. The second connecting portion 31b includes a second face 31B facing the second terminal 20T.

As shown in FIG. 5A, the first heat dissipation portion 35a and the third heat dissipation portion 35c are connected to the first connecting portion 31a. The second heat dissipation portion 35b and the fourth heat dissipation portion 35d are connected to the second connecting portion 31b.

The second direction D2 from the first heat dissipation portion 35a to the second heat dissipation portion 35b crosses the first direction D1 crossing the first face 31A. The first direction D1 crosses the second face 31B. The first direction D1 is, for example, the Z-axis direction. The second direction D2 may be, for example, the X-axis direction.

At least a part of the first heat dissipation portion 35a and at least a part of the second heat dissipation portion 35b are along the first direction D1 and the third direction D3. The third direction D3 crosses a plane including the first direction D1 and the second direction D2. The third direction D3 is, for example, the Y-axis direction.

A direction from the third heat dissipation portion 35c to the fourth heat dissipation portion 35d is along the second direction D2. At least a part of the third heat dissipation portion 35c and at least a part of the fourth heat dissipation portion 35d are along the first direction D1 and the second direction D2.

The first curved portion 33a connects the first connecting portion 31a and the second connecting portion 31b. A part of the first curved portion 33a faces the first heat dissipation portion 35a in the second direction D2. Another part of the first curved portion 33a faces the second heat dissipation portion 35b in the second direction D2. At least a part of the first curved portion 33a is located between the first heat dissipation portion 35a and the second heat dissipation portion 35b.

In the secondary battery 120, the first heat dissipation portion 35a, the second heat dissipation portion 35b, the third heat dissipation portion 35c, and the fourth heat dissipation portion 35d are provided in the bus bar 30. Thereby, for example, high heat dissipation is obtained. According to the embodiment, it is possible to provide a secondary battery and a bus bar capable of improving heat dissipation.

In the secondary battery 120, the first protruding portion 31e and the second protruding portion 31f may be provided. A low electrical resistance is easily obtained. For example, heat generation during energization is suppressed.

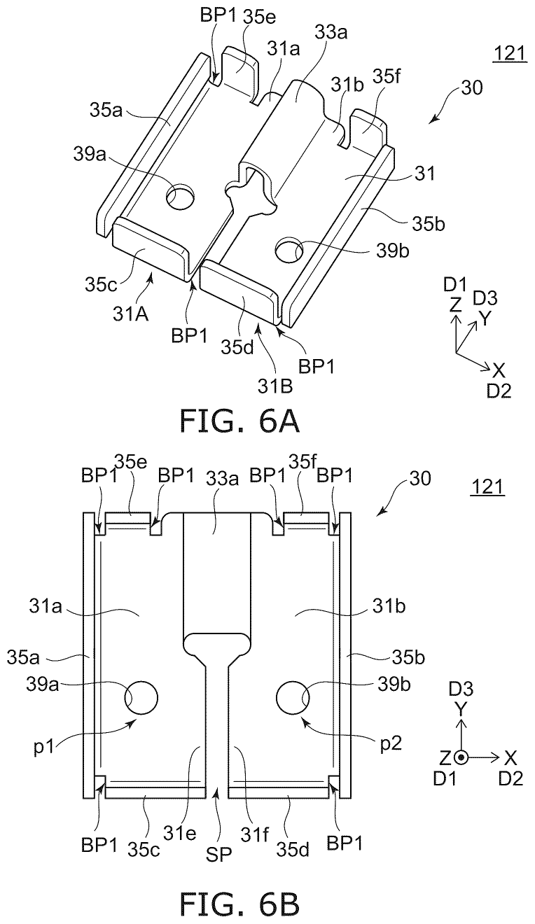

FIGS. 6A and 6B are schematic views illustrating a part of a secondary battery according to the second embodiment.

FIGS. 6A and 6B illustrate the bus bar 30 in a secondary battery 121 according to the embodiment. FIG. 6A is a perspective view. FIG. 6B is a plan view.

As shown in FIG. 6B, in the secondary battery 121 according to the embodiment, the bus bar 30 includes a fifth heat dissipation portion 35e and a sixth heat dissipation portion 35f. Except for this, the configuration of the secondary battery 121 may be the same as the configuration of the secondary battery 120.

The fifth heat dissipation portion 35e is connected to the first connecting portion 31a. The sixth heat dissipation portion 35f is connected to the second connecting portion 31b. A direction from the fifth heat dissipation portion 35e to the sixth heat dissipation portion 35f is along the second direction D2. At least a part of the fifth heat dissipation portion 35e and at least a part of the sixth heat dissipation portion 35f are along the first direction D1 and the second direction D2. A direction from the third heat dissipation portion 35c to the fifth heat dissipation portion 35e is along the third direction D3. A direction from the fourth heat dissipation portion 35d to the sixth heat dissipation portion 35f is along the third direction D3.

Also in the secondary battery 121, high heat dissipation is obtained. In the secondary battery 121, by providing the fifth heat dissipation portion 35e and the sixth heat dissipation portion 35f, higher heat dissipation can be obtained.

In the secondary battery 121, the first protruding portion 31e and the second protruding portion 31f may be provided. A low electrical resistance is easily obtained. For example, heat generation during energization is suppressed.

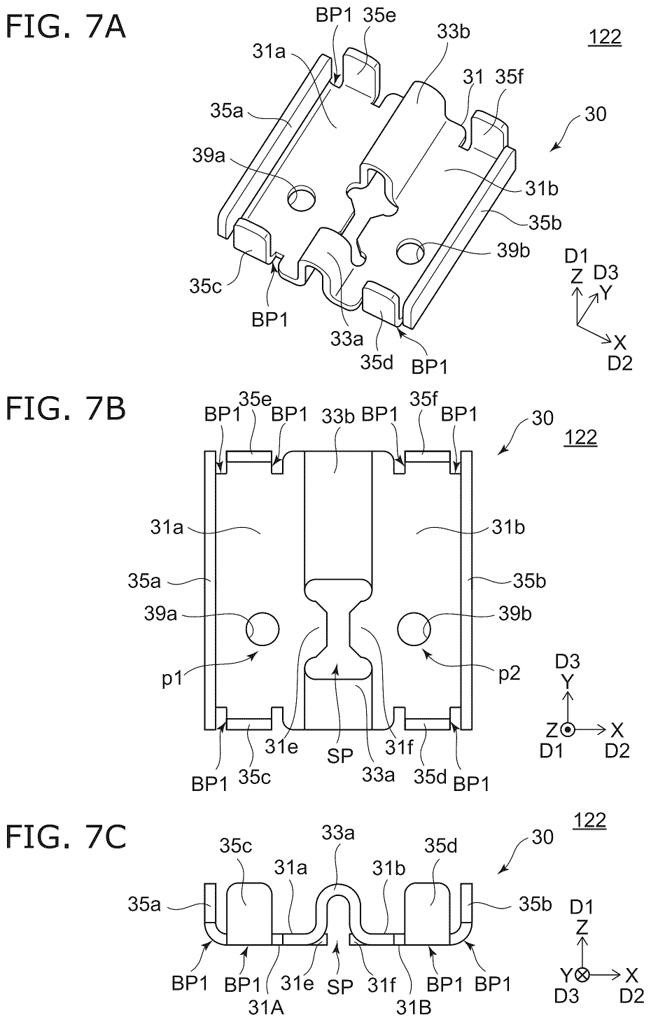

FIGS. 7A to 7C are schematic views illustrating a part of a secondary battery according to the second embodiment.

FIGS. 7A to 7C illustrate the bus bar 30 in a secondary battery 122 according to the embodiment. FIG. 7A is a perspective view. FIG. 7B is a plan view. FIG. 7C is a side view. As shown in FIG. 7A, in the secondary battery 122 according to the embodiment, the bus bar 30 includes the first curved portion 33a and the second curved portion 33b. Except for this, the configuration of the secondary battery 122 may be the same as the configuration of the secondary battery 121.

As shown in FIGS. 7A and 7B, the first curved portion 33a connects the first connecting portion 31a and the second connecting portion 31b. A part of the first curved portion 33a faces the first heat dissipation portion 35a in the second direction D2. Another part of the first curved portion 33a faces the second heat dissipation portion 35b in the second direction D2. At least a part of the first curved portion 33a is located between the first heat dissipation portion 35a and the second heat dissipation portion 35b.

As shown in FIGS. 7A and 7B, the second curved portion 33b connects the first connecting portion 31a and the second connecting portion 31b. A part of the second curved portion 33b faces the first heat dissipation portion 35a in the second direction D2. Another part of the second curved portion 33b faces the second heat dissipation portion 35b in the second direction D2. At least a part of the second curved portion 33b is located between the first heat dissipation portion 35a and the second heat dissipation portion 35b.

The direction from the first curved portion 33a to the second curved portion 33b is along the third direction D3. The second curved portion 33b is separated from the first curved portion 33a in the third direction. Also in the secondary battery 122, high heat dissipation is obtained.

In the secondary battery 122, the first protruding portion 31e and the second protruding portion 31f may be provided. A low electrical resistance is easily obtained. For example, heat generation during energization is suppressed.

### Third Embodiment

The third embodiment relates to the bus bar 30 described in the first embodiment. The bus bar 30 according to the third embodiment includes, for example, the base portion 31, the first heat dissipation portion 35a, the first opposing heat dissipation portion 37a, the second heat dissipation portion 35b, the second opposing heat dissipation portion 37b, the third heat dissipation portion 35c, the third opposing heat dissipation portion 37c, the fourth heat dissipation portion 35d, and the fourth opposing heat dissipation portion 37d (see FIG. 1A and the like).

As shown in FIG. 1A, the base portion 31 includes the first connecting portion 31a and the second connecting portion 31b. The first direction D1 from the first connecting portion 31a to the first opposing heat dissipation portion 37a crosses the second direction D2 from the first connecting portion 31a to the second connecting portion 31b. The first opposing heat dissipation portion 37a is separated from the first connecting portion 31a in the first direction D1. The first heat dissipation portion 35a is continuous with the first connecting portion 31a and the first opposing heat dissipation portion 37a.

As shown in FIG. 1A, the direction from the second connecting portion 31b to the second opposing heat dissipation portion 37b is along the first direction D1. The second opposing heat dissipation portion 37b is separated from the second connecting portion 31b in the first direction D1. The second heat dissipation portion 35b is continuous with the second connecting portion 31b and the second opposing heat dissipation portion 37b.

As shown in FIG. 1A, the direction from the first connecting portion 31a to the third opposing heat dissipation portion 37c is along the first direction D1. The third opposing heat dissipation portion 37c is separated from the first connecting portion 31a in the first direction D1. The third direction D3 from the first opposing heat dissipation portion 37a to the third opposing heat dissipation portion 37c crosses a plane including the first direction D1 and the second direction D2. The third heat dissipation portion 35c is continuous with the first connecting portion 31a and the third opposing heat dissipation portion 37c. As shown in FIG. 1A, the direction from the second connecting portion 31b to the fourth opposing heat dissipation portion 37d is along the first direction D1. The fourth opposing heat dissipation portion 37d is separated from the second connecting portion 31b in the first direction D1. The direction from the second opposing heat dissipation portion 37b to the fourth opposing heat dissipation portion 37d is along the third direction D3. The fourth heat dissipation portion 35d is continuous with the second connecting portion 31b and the fourth opposing heat dissipation portion 37d.

In the bus bar 30 according to the third embodiment, it is possible to provide a bus bar capable of improving heat dissipation. In the third embodiment, any configuration described in relation to the first embodiment may be applied.

### Fourth Embodiment

The fourth embodiment relates to the bus bar 30 described in the second embodiment. The bus bar 30 according to the fourth embodiment includes, for example, the base portion 31, the first heat dissipation portion 35a, the second heat dissipation portion 35b, the third heat dissipation portion 35c, and the fourth heat dissipation portion 35d (see FIG. 5A and the like). As shown in FIG. 5A, the base portion 31 includes the first connecting portion 31a, the second connecting portion 31b, and the first curved portion 33a. The first connecting portion 31a includes the first face 31A. The second connecting portion 31b includes the second face 31B. The first face 31A and the second face 31B cross the first direction D1.

As shown in FIG. 5A, the first heat dissipation portion 35a and the third heat dissipation portion 35c are connected to the first connecting portion 31a. The second heat dissipation portion 35b and the fourth heat dissipation portion 35d are connected to the second connecting portion 31b.

As shown in FIG. 5A, the second direction D2 from the first heat dissipation portion 35a to the second heat dissipation portion 35b crosses the first direction D1. The direction from the third heat dissipation portion 35c to the fourth heat dissipation portion 35d is along the second direction D2. At least a part of the first heat dissipation portion 35a and at least a part of the second heat dissipation portion 35b are along the first direction D1 and the third direction D3. The third direction D3 crosses a plane including the first direction D1 and the second direction D2.

As shown in FIG. 5A, at least a part of the third heat dissipation portion 35c and at least a part of the fourth heat dissipation portion 35d are along the first direction D1 and the second direction D2. The first curved portion 33a connects the first connecting portion 31a and the second connecting portion 31b. A part of the first curved portion 33a faces the first heat dissipation portion 35a in the second direction D2. Another part of the first curved portion 33a faces the second heat dissipation portion 35b in the second direction D2.

In the bus bar 30 according to the fourth embodiment, a bus bar capable of improving heat dissipation can be provided. In the fourth embodiment, any configuration described in the second embodiment may be applied.

Embodiments may include the following Technical proposals:

### (Technical Proposal 1)

A secondary battery, comprising:
a first battery cell including a first terminal;
a second battery cell including a second terminal; and
a bus bar,
the bus bar including a base portion, a first heat dissipation portion, a first opposing heat dissipation portion, a second heat dissipation portion, and a second opposing heat dissipation portion,
the base portion including a first connecting portion and a second connecting portion,
the first connecting portion being electrically connected to the first terminal,
the second connecting portion being electrically connected to the second terminal,
a first direction from the first connecting portion to the first opposing heat dissipating portion crossing a second direction from the first connecting portion to the second connecting portion,
the first opposing heat dissipation portion being separated from the first connecting portion in the first direction,
the first heat dissipation portion being continuous with the first connecting portion and the first opposing heat dissipation portion,
a direction from the second connecting portion to the second opposing heat dissipation portion being along the first direction,
the second opposing heat dissipation portion being separated from the second connecting portion in the first direction, and
the second heat dissipation portion being continuous with the second connecting portion and the second opposing heat dissipation portion.

### (Technical Proposal 2)

The secondary battery according to Technical proposal 1, wherein
the first battery cell includes a first positive electrode terminal and a first negative electrode terminal,
the second battery cell includes a second negative electrode terminal and a second positive electrode terminal,
the first terminal is one of the first positive electrode terminal and the first negative electrode terminal, and
the second terminal is one of the second negative electrode terminal and the second positive electrode terminal.

### (Technical Proposal 3)

The secondary battery according to Technical proposal 1 or 2, wherein
the bus bar further includes a third heat dissipation portion, a third opposing heat dissipation portion, a fourth heat dissipation portion, and a fourth opposing heat dissipation portion,
a direction from the first connecting portion to the third opposing heat dissipation portion is along the first direction,
the third opposing heat dissipation portion is separated from the first connecting portion in the first direction,
a third direction from the first opposing heat dissipation portion to the third opposing heat dissipation portion crosses a plane including the first direction and the second direction,
the third heat dissipation portion is continuous with the first connecting portion and the third opposing heat dissipation portion,
a direction from the second connecting portion to the fourth opposing heat dissipation portion is along the first direction,
the fourth opposing heat dissipation portion is separated from the second connecting portion in the first direction,
a direction from the second opposing heat dissipation portion to the fourth opposing heat dissipation portion is along the third direction, and
the fourth heat dissipation portion is continuous with the second connecting portion and the fourth opposing heat dissipation portion.

### (Technical Proposal 4)

The secondary battery according to Technical proposal 3, wherein
the third opposing heat dissipation portion is separated from the first opposing heat dissipation portion in the third direction, and
the fourth opposing heat dissipation portion is separated from the second opposing heat dissipation portion in the third direction.

### (Technical Proposal 5)

The secondary battery according to Technical proposal 3 or 4, wherein
the base portion further includes a second curved portion connecting the first connecting portion and the second connecting portion,
a part of the second curved portion faces the third heat dissipation portion in the second direction, and
another part of the second curved portion faces the fourth heat dissipation portion in the second direction.

### (Technical Proposal 6)

The secondary battery according to any one of Technical proposals 1-5, wherein
the base portion further includes a first curved portion portion,
a part of the first curved portion faces the first heat dissipation portion in the second direction, and
another part of the first curved portion faces the second heat dissipation portion in the second direction.

### (Technical Proposal 7)

The secondary battery according to Technical proposal 1, wherein
the base portion further includes a first curved portion connecting the first connecting portion and the second connecting portion,
a part of the first curved portion faces the first heat dissipation portion in the second direction, and
another part of the first curved portion faces the second heat dissipation portion in the second direction.

### (Technical Proposal 8)

The secondary battery according to Technical proposal 7, wherein
the first connecting portion includes a first position,
the first connecting portion is connected to the first terminal at the first position,
the second connecting portion includes a second position,
the second connecting portion is connected to the second terminal at the second position,
the first curved portion is provided except between the first position and the second position, and
a first gap is provided between the first connection porting and the second connecting portion between the first position and the second position.

### (Technical Proposal 9)

The secondary battery according to any one of Technical proposals 1-7, wherein
the first connecting portion includes a first position,
the first connecting portion is connected to the first terminal at the first position,
the second connecting portion includes a second position,
the second connecting portion is connected to the second terminal at the second position,
the first connecting portion includes a first protruding portion,
the first protruding portion protrudes toward the second position,
the second connecting portion includes a second protruding portion, and
the second protruding portion protrudes toward the first position.

### (Technical Proposal 10)

The secondary battery according to any one of Technical proposals 1-9, wherein
at least a part of the first opposing heat dissipation portion extends along a first crossing plane crossing the first direction, and
at least a part of the second opposing heat dissipation portion is along the first crossing plane.

### (Technical Proposal 11)

The secondary battery according to any one of Technical proposals 1-10, wherein
at least a part of the first heat dissipation portion is along a second crossing plane crossing the second direction.

### (Technical Proposal 12)

The secondary battery according to any one of Technical proposals 1-10, wherein
at least a part of the first heat dissipation portion is along a first plane including the first direction and the second direction.

### (Technical Proposal 13)

A secondary battery, comprising:
a first battery cell including a first terminal;
a second battery cell including a second terminal; and
a bus bar,
the bus bar including a base portion, a first heat dissipation portion, a second heat dissipation portion, a third heat dissipation portion, and a fourth heat dissipation portion,
the base portion including a first connecting portion, a second connecting portion, and a first curved portion,
the first connecting portion being electrically connected to the first terminal, and
the second connecting portion being electrically connected to the second terminal,
the first connecting portion including a first face facing the first terminal,
the second connecting portion including a second face facing the second terminal,
the first heat dissipation portion and the third heat dissipation portion being connected to the first connecting portion,
the second heat dissipation portion and the fourth heat dissipation portion being connected to the second connecting portion,
a second direction from the first heat dissipation portion to the second heat dissipation portion crossing a first direction crossing the first surface,
a direction from the third heat dissipation portion to the fourth heat dissipation portion being along the second direction,
at least a part of the first heat dissipation portion and at least a part of the second heat dissipation portion being along the first direction and a third direction,
the third direction crossing a plane including the first direction and the second direction,
at least a part of the third heat dissipation portion and at least a part of the fourth heat dissipation portion being along the first direction and the second direction,
the first curved portion connecting the first connecting portion and the second connecting portion,
a part of the first curved portion facing the first heat dissipation portion in the second direction, and
another part of the first curved portion facing the second heat dissipation portion in the second direction.

### (Technical Proposal 14)

A bus bar, comprising:
a base portion including a first connecting portion and a second connecting portion;
a first heat dissipation portion;
a first opposing heat dissipation portion;
a second heat dissipation portion;
a second opposing heat dissipation portion;
a third heat dissipation portion;
a third opposing heat dissipation portion;
a fourth heat dissipation portion; and
a fourth opposing heat dissipation portion,
a first direction from the first connecting portion to the first opposing heat dissipating portion crossing a second direction from the first connecting portion to the second connecting portion,
the first opposing heat dissipation portion being separated from the first connecting portion in the first direction,
the first heat dissipation portion being continuous with the first connecting portion and the first opposing heat dissipation portion,
a direction from the second connecting portion to the second opposing heat dissipation portion being along the first direction,
the second opposing heat dissipation portion being separated from the second connecting portion in the first direction,
the second heat dissipation portion being continuous with the second connecting portion and the second opposing heat dissipation portion,
a direction from the first connecting portion to the third opposing heat dissipation portion being along the first direction,
the third opposing heat dissipation portion being separated from the first connecting portion in the first direction,
a third direction from the first opposing heat dissipation portion to the third opposing heat dissipation portion crossing a plane including the first direction and the second direction,
the third heat dissipation portion being continuous with the first connecting portion and the third opposing heat dissipation portion,
a direction from the second connecting portion to the fourth opposing heat dissipation portion being along the first direction,
the fourth opposing heat dissipation portion being separated from the second connecting portion in the first direction,
a direction from the second opposing heat dissipation portion to the fourth opposing heat dissipation portion being along the third direction, and
the fourth heat dissipation portion being continuous with the second connecting portion and the fourth opposing heat dissipation portion.

### (Technical Proposal 15)

The bus bar according to Technical proposal 14, wherein
the third opposing heat dissipation portion is separated from the first opposing heat dissipation portion in the third direction, and
the fourth opposing heat dissipation portion is separated from the second opposing heat dissipation portion in the third direction.

### (Technical Proposal 16)

The bus bar according to Technical proposal 14 or 15, wherein
the base portion further includes a first curved portion connecting the first connecting portion and the second connecting portion,
a part of the first curved portion faces the first heat dissipation portion in the second direction, and
another part of the first curved portion faces the second heat dissipation portion in the second direction.

### (Technical Proposal 17)

The bus bar according to Technical proposal 14 or 15, wherein
the base portion further includes a second curved portion portion,
a part of the second curved portion faces the third heat dissipation portion in the second direction, and
another part of the second curved portion faces the fourth heat dissipation portion in the second direction.

### (Technical Proposal 18)

The bus bar according to Technical proposal 16, wherein
the first connecting portion includes a first position,
the first connecting portion is configured to be connected to a first terminal of a first battery cell at the first position,
the second connecting portion includes a second position,
the second connecting portion is configured to be connected to a second terminal of a second battery cell at the second position,
the first curved portion is provided except between the first position and the second position, and
a first gap is provided between the first connecting portion and the second connecting portion between the first position and the second position.

### (Technical Proposal 19)

The bus bar according to Technical proposal 14 or 15, wherein
the first connecting portion includes a first position,
the first connecting portion is configured to be connected to a first terminal of a first battery cell at the first position,
the second connecting portion includes a second position,
the second connecting portion is configured to be connected to a second terminal of a second battery cell at the second position,
the first connecting portion includes a first protruding portion,
the first protruding portion protrudes toward the second position,
the second connecting portion includes a second protruding portion, and
the second protruding portion protrudes toward the first position.

### (Technical Proposal 20)

A bus bar, comprising:
a base portion including a first connecting portion, a second connecting portion, and a first curved portion;
a first heat dissipation portion;
a second heat dissipation portion;
a third heat dissipation portion; and
a fourth heat dissipation portion,
the first connecting portion including a first face,
the second connecting portion includes a second face,
the first face and the second face crossing a first direction,
the first heat dissipation portion and the third heat dissipation portion being connected to the first connecting portion,
the second heat dissipation portion and the fourth heat dissipation portion being connected to the second connecting portion,
a second direction from the first heat dissipation portion to the second heat dissipation portion crossing the first direction,
a direction from the third heat dissipation portion to the fourth heat dissipation portion being along the second direction,
at least a part of the first heat dissipation portion and at least a part of the second heat dissipation portion being along the first direction and a third direction,
the third direction crossing a plane including the first direction and the second direction,
at least a part of the third heat dissipation portion and at least a part of the fourth heat dissipation portion being along the first direction and the second direction,
the first curved portion connecting the first connecting portion and the second connecting portion,
a part of the first curved portion facing the first heat dissipation portion in the second direction, and
another part of the first curved portion facing the second heat dissipation portion in the second direction.

According to the embodiment, it is possible to provide a secondary battery and a bus bar capable of improving heat dissipation.

In the specification of the application, “perpendicular” and “parallel” refer to not only strictly perpendicular and strictly parallel but also include, for example, the fluctuation due to manufacturing processes, etc. It is sufficient to be substantially perpendicular and substantially parallel.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in secondary batteries and bus bars such as base portions, connecting portions, heat dissipation portions, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all secondary batteries and all bus bars practicable by an appropriate design modification by one skilled in the art based on the secondary batteries and the bus bars described above as embodiments of the invention also are within the scope of the invention to the extent that the purport of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A secondary battery, comprising:
a first battery cell including a first terminal;
a second battery cell including a second terminal; and
a bus bar,
the bus bar including a base portion, a first heat dissipation portion, a first opposing heat dissipation portion, a second heat dissipation portion, and a second opposing heat dissipation portion,
the base portion including a first connecting portion and a second connecting portion,
the first connecting portion being electrically connected to the first terminal,
the second connecting portion being electrically connected to the second terminal,
a first direction from the first connecting portion to the first opposing heat dissipating portion crossing a second direction from the first connecting portion to the second connecting portion,
the first opposing heat dissipation portion being separated from the first connecting portion in the first direction,
the first heat dissipation portion being continuous with the first connecting portion and the first opposing heat dissipation portion,
a direction from the second connecting portion to the second opposing heat dissipation portion being along the first direction,
the second opposing heat dissipation portion being separated from the second connecting portion in the first direction, and
the second heat dissipation portion being continuous with the second connecting portion and the second opposing heat dissipation portion.

2. The secondary battery according to claim 1, wherein
the first battery cell includes a first positive electrode terminal and a first negative electrode terminal,
the second battery cell includes a second negative electrode terminal and a second positive electrode terminal,
the first terminal is one of the first positive electrode terminal and the first negative electrode terminal, and
the second terminal is one of the second negative electrode terminal and the second positive electrode terminal.

3. The secondary battery according to claim 1, wherein
the bus bar further includes a third heat dissipation portion, a third opposing heat dissipation portion, a fourth heat dissipation portion, and a fourth opposing heat dissipation portion,
a direction from the first connecting portion to the third opposing heat dissipation portion is along the first direction,
the third opposing heat dissipation portion is separated from the first connecting portion in the first direction,
a third direction from the first opposing heat dissipation portion to the third opposing heat dissipation portion crosses a plane including the first direction and the second direction,
the third heat dissipation portion is continuous with the first connecting portion and the third opposing heat dissipation portion,
a direction from the second connecting portion to the fourth opposing heat dissipation portion is along the first direction,
the fourth opposing heat dissipation portion is separated from the second connecting portion in the first direction,
a direction from the second opposing heat dissipation portion to the fourth opposing heat dissipation portion is along the third direction, and
the fourth heat dissipation portion is continuous with the second connecting portion and the fourth opposing heat dissipation portion.

4. The secondary battery according to claim 3, wherein
the third opposing heat dissipation portion is separated from the first opposing heat dissipation portion in the third direction, and
the fourth opposing heat dissipation portion is separated from the second opposing heat dissipation portion in the third direction.

5. The secondary battery according to claim 3, wherein
the base portion further includes a second curved portion connecting the first connecting portion and the second connecting portion,
a part of the second curved portion faces the third heat dissipation portion in the second direction, and
another part of the second curved portion faces the fourth heat dissipation portion in the second direction.

6. The secondary battery according to claim 1, wherein
the base portion further includes a first curved portion connecting the first connecting portion and the second connecting portion,
a part of the first curved portion faces the first heat dissipation portion in the second direction, and
another part of the first curved portion faces the second heat dissipation portion in the second direction.

7. The secondary battery according to claim 1, wherein
the base portion further includes a first curved portion connecting the first connecting portion and the second connecting portion,
a part of the first curved portion faces the first heat dissipation portion in the second direction, and
another part of the first curved portion faces the second heat dissipation portion in the second direction.

8. The secondary battery according to claim 7, wherein
the first connecting portion includes a first position,
the first connecting portion is connected to the first terminal at the first position,
the second connecting portion includes a second position,
the second connecting portion is connected to the second terminal at the second position,
the first curved portion is provided except between the first position and the second position, and
a first gap is provided between the first connection porting and the second connecting portion between the first position and the second position.

9. The secondary battery according to claim 1, wherein
the first connecting portion includes a first position,
the first connecting portion is connected to the first terminal at the first position,
the second connecting portion includes a second position,
the second connecting portion is connected to the second terminal at the second position,
the first connecting portion includes a first protruding portion,
the first protruding portion protrudes toward the second position,
the second connecting portion includes a second protruding portion, and
the second protruding portion protrudes toward the first position.

10. The secondary battery according to claim 1, wherein
at least a part of the first opposing heat dissipation portion extends along a first crossing plane crossing the first direction, and
at least a part of the second opposing heat dissipation portion is along the first crossing plane.

11. The secondary battery according to claim 1, wherein
at least a part of the first heat dissipation portion is along a second crossing plane crossing the second direction.

12. The secondary battery according to claim 1, wherein
at least a part of the first heat dissipation portion is along a first plane including the first direction and the second direction.

13. A secondary battery, comprising:
a first battery cell including a first terminal;
a second battery cell including a second terminal; and
a bus bar,
the bus bar including a base portion, a first heat dissipation portion, a second heat dissipation portion, a third heat dissipation portion, and a fourth heat dissipation portion,
the base portion including a first connecting portion, a second connecting portion, and a first curved portion,
the first connecting portion being electrically connected to the first terminal, and
the second connecting portion being electrically connected to the second terminal,
the first connecting portion including a first face facing the first terminal,
the second connecting portion including a second face facing the second terminal,
the first heat dissipation portion and the third heat dissipation portion being connected to the first connecting portion,
the second heat dissipation portion and the fourth heat dissipation portion being connected to the second connecting portion,
a second direction from the first heat dissipation portion to the second heat dissipation portion crossing a first direction crossing the first surface,
a direction from the third heat dissipation portion to the fourth heat dissipation portion being along the second direction,
at least a part of the first heat dissipation portion and at least a part of the second heat dissipation portion being along the first direction and a third direction,
the third direction crossing a plane including the first direction and the second direction,
at least a part of the third heat dissipation portion and at least a part of the fourth heat dissipation portion being along the first direction and the second direction,
the first curved portion connecting the first connecting portion and the second connecting portion,
a part of the first curved portion facing the first heat dissipation portion in the second direction, and
another part of the first curved portion facing the second heat dissipation portion in the second direction.

14. A bus bar, comprising:
a base portion including a first connecting portion and a second connecting portion;
a first heat dissipation portion;
a first opposing heat dissipation portion;
a second heat dissipation portion;
a second opposing heat dissipation portion;
a third heat dissipation portion;
a third opposing heat dissipation portion;
a fourth heat dissipation portion; and
a fourth opposing heat dissipation portion,
a first direction from the first connecting portion to the first opposing heat dissipating portion crossing a second direction from the first connecting portion to the second connecting portion,
the first opposing heat dissipation portion being separated from the first connecting portion in the first direction,
the first heat dissipation portion being continuous with the first connecting portion and the first opposing heat dissipation portion,
a direction from the second connecting portion to the second opposing heat dissipation portion being along the first direction,
the second opposing heat dissipation portion being separated from the second connecting portion in the first direction,
the second heat dissipation portion being continuous with the second connecting portion and the second opposing heat dissipation portion,
a direction from the first connecting portion to the third opposing heat dissipation portion being along the first direction,
the third opposing heat dissipation portion being separated from the first connecting portion in the first direction,
a third direction from the first opposing heat dissipation portion to the third opposing heat dissipation portion crossing a plane including the first direction and the second direction,
the third heat dissipation portion being continuous with the first connecting portion and the third opposing heat dissipation portion,
a direction from the second connecting portion to the fourth opposing heat dissipation portion being along the first direction,
the fourth opposing heat dissipation portion being separated from the second connecting portion in the first direction,
a direction from the second opposing heat dissipation portion to the fourth opposing heat dissipation portion being along the third direction, and
the fourth heat dissipation portion being continuous with the second connecting portion and the fourth opposing heat dissipation portion.

15. The bus bar according to claim 14, wherein
the third opposing heat dissipation portion is separated from the first opposing heat dissipation portion in the third direction, and
the fourth opposing heat dissipation portion is separated from the second opposing heat dissipation portion in the third direction.

16. The bus bar according to claim 14, wherein
the base portion further includes a first curved portion portion,
a part of the first curved portion faces the first heat dissipation portion in the second direction, and
another part of the first curved portion faces the second heat dissipation portion in the second direction.

17. The bus bar according to claim 14, wherein
the base portion further includes a second curved portion connecting the first connecting portion and the second connecting portion,
a part of the second curved portion faces the third heat dissipation portion in the second direction, and
another part of the second curved portion faces the fourth heat dissipation portion in the second direction.

18. The bus bar according to claim 16, wherein
the first connecting portion includes a first position,
the first connecting portion is configured to be connected to a first terminal of a first battery cell at the first position,
the second connecting portion includes a second position,
the second connecting portion is configured to be connected to a second terminal of a second battery cell at the second position,
the first curved portion is provided except between the first position and the second position, and
a first gap is provided between the first connecting portion and the second connecting portion between the first position and the second position.

19. The bus bar according to claim 14, wherein
the first connecting portion includes a first position,
the first connecting portion is configured to be connected to a first terminal of a first battery cell at the first position,
the second connecting portion includes a second position,
the second connecting portion is configured to be connected to a second terminal of a second battery cell at the second position,
the first connecting portion includes a first protruding portion,
the first protruding portion protrudes toward the second position,
the second connecting portion includes s a second protruding portion, and
the second protruding portion protrudes toward the first position.

20. A bus bar, comprising:
a base portion including a first connecting portion, a second connecting portion, and a first curved portion;
a first heat dissipation portion;
a second heat dissipation portion;
a third heat dissipation portion; and
a fourth heat dissipation portion,
the first connecting portion including a first face,
the second connecting portion includes a second face,
the first face and the second face crossing a first direction,
the first heat dissipation portion and the third heat dissipation portion being connected to the first connecting portion,
the second heat dissipation portion and the fourth heat dissipation portion being connected to the second connecting portion,
a second direction from the first heat dissipation portion to the second heat dissipation portion crossing the first direction,
a direction from the third heat dissipation portion to the fourth heat dissipation portion being along the second direction,
at least a part of the first heat dissipation portion and at least a part of the second heat dissipation portion being along the first direction and a third direction,
the third direction crossing a plane including the first direction and the second direction,
at least a part of the third heat dissipation portion and at least a part of the fourth heat dissipation portion being along the first direction and the second direction,
the first curved portion connecting the first connecting portion and the second connecting portion,
a part of the first curved portion facing the first heat dissipation portion in the second direction, and
another part of the first curved portion facing the second heat dissipation portion in the second direction.
